(19) United States
(12) Patent Application Publication
(10) Pub. No.: US 2010/0014293 A1
(43) Pub. Date: Jan. 21, 2010

(54) LIGHTING UNIT WITH ROTATABLE BODY

(75) Inventors: Jens Pollmann-Retsch, Aachen (DE); Ralf Dorscheid, Kerkrade (NL); Norbert Dettmann, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/440,595

(22) PCT Filed: Sep. 10, 2007
(86) PCT No.: PCT/IB2007/053644

§ 371 Date: Mar. 10, 2009

(30) Foreign Application Priority Data
Sep. 14, 2006 (EP) 06120667.8

(51) Int. Cl. F21V 21/30; F21V 29/00

(52) U.S. Cl. 362/296.01; 362/427

(57) ABSTRACT

In a lighting unit with a holder (21) and a body (22), the body (22) is pivotally hinged to the holder (21) for rotation around at least a first axis of rotation. The body (22) comprises a support (1) for a lamp (2), which support (1) is pivotally hinged to the body (22) for rotation around a second axis, where upon a rotational movement of the body (22) around the first axis of rotation, the support (1) rotates conversely around the second axis, so that the defined orientation of the lamp (2) in the environment is maintained.

The invention relates to a lighting unit with a holder and a body, which body is pivotally hinged to the holder having at least a first axis of rotation.

Lighting units with a rotatable body are common today in professional lighting applications, for example theatre or broadcasting lighting. Such lighting units are rotatable around at least a first axis of rotation, to direct an output beam precisely to a desired location. A special type of such lighting units are lighting units, which can be positioned automatically, often referred to as “moving head lighting units” or “moving heads”. These lighting units enable to automatically direct the beam of light to a desired position using a suitable control. Such moving heads are usually rotatable around two perpendicular axes to enable multiple degrees of freedom for positioning the output beam.

Moving heads will gain in significance in the near future also for applications, where—in addition to standard scene-illumination—more advanced effects shall be created, for example for video projection purposes. Moving heads suitable for creating these types of effects using projection technology are typically referred to as “digital spotlights”. Various lamp types exist, usable for these applications, as known from e.g. video projectors. A problem arises when using high-power lamps, since a variety of high-power lamps are advantageously operated in a defined mounting orientation, which is difficult to maintain in a moving head. Such a defined orientation can be, for example, advantageous, because of a directional output beam pattern or because of a special lamp-cooling design. An example of such a lamp, a CPL (compact power light) lamp, is disclosed in WO 02/056334. This lamp shall be mounted in a defined orientation because of a defined cooling arrangement.

To address this problem, document WO 2004/0859191 discloses a support for an oriented lamp in a moving head. As can be seen from the document, the support is arranged within a non-moving part of the moving head.

Since this construction may not be suitable for all applications, it is an object of the current invention to enable an alternate way for mounting the above-mentioned lamps in a moving head.

The object is solved according to the invention by a lighting unit according to claim 1, a method for supporting an oriented lamp in a lighting unit according to claim 9 and a lamp socket according to claim 11. Dependent claims relate to preferred embodiments of the invention.

According to the invention, the lighting unit comprises a holder and a body, which body is pivotally hinged to the holder around at least a first axis of rotation. While the holder is designed to mount the lighting unit, for example to the ceiling of a theatre, the body comprises at least a support for a lamp. The support for the lamp is designed, so as to safely hold the lamp. Therefore, any suitable type of support may be used. The body may comprise other components of the lighting unit, depending on the application, for example optical components, such as lenses, filters, mirrors, LCD elements or DLP elements, a power supply, a ballast, electronic control circuits and, in case the lighting unit is a moving head, electromechanical actuators and corresponding control circuits. To pivotally hinge the body to the holder, any type of bearing suitable for the application may be used, for example a ball bearing or a ceramic bearing.

According to the invention, the support is pivotally hinged to the body, rotatable around a second axis of rotation, parallel to the first axis. The support is designed to hold a lamp, which emits light at least in the direction of the second axis, parallel to the first axis.

According to the present invention, the first and the second axis of rotation are parallel to each other, which leads to a “ferris wheel” type design. When the body of the lighting unit is rotated around the first axis of rotation, for example to direct the beam of light from one position to another, it is possible, to conversely rotate the support around the second axis, so that the orientation of the lamp is maintained. In the context of the present invention, the term “orientation” refers to the absolute orientation of the lamp in the environment, wherein the environment can be defined, most broadly, as the gravitational field. Thus, it is possible to use oriented lamps in a lighting device with a rotatable body, as for example in a moving head device.

To enable the rotation of the support against the body, a bearing may preferably be provided between the body and the support, where any type of suitable bearing may be used. For example, a ball bearing or a ceramic bearing may be used. The bearing shall most preferably enable smooth rotational movements of the support.

In a preferred embodiment of the invention, the support is operable for maintaining the orientation of the lamp independent of the rotational position between body and holder. Preferably, the support is operable to determine a rotational movement of the body using gravity, for example by having an unbalanced mass element, attached to the support, spaced from the second axis of rotation. Upon rotational movement of the body around the first axis, the mass element then creates a torque, which rotates the support conversely around the second axis automatically. As a further example, the support may be formed with a gyroscope-like design.

Alternatively, the support or the body may include means, designed to determine a rotational movement of the body around the first axis of rotation and then to rotate the support conversely around the second axis, when a rotational movement of the body is detected.

Exemplary, electrical actuators with a suitable control circuit and a sensor may be used to detect a rotational movement of the body and to conversely rotate the support. As a further example, it is possible to mount the support to a non-movable part of the lighting unit, for example the holder, so that a rotational movement of the body around the first axis does not affect the rotational position of the support and thus the orientation of the lamp.

Preferably, the support may have further elements, for example electrical connections or temperature sensors. Most preferably, the support comprises a lamp socket and/or a reflector. The lamp socket is provided to support the lamp and to establish the electrical connections between the lamp and the power supply, arranged within the body of the lighting unit. The lamp socket therefore should be adapted to the specific type of lamp, used in the lighting unit. Depending on the type of lamp, a reflector may preferably be used to form a directed beam of light.

Several types of high power lamps need to be cooled at a defined position of the lamp, for example CPL (compact power light) lamps. CPL lamps are based on ultra-high pressure gas discharge lamp technology. To obtain a very high luminous efficacy, the gas pressure in a CPL lamp has to be maintained as high as possible. Therefore, the lamp is operated at a high temperature. However, this may lead to lifetime problems, since an overall high temperature can result in devitrification of the lamp bulb, especially in the region above the light arc, due to convection inside the discharge space. To object this problem, CPL lamps are cooled at their upper side, above the light arc.

In a preferred embodiment, the body therefore comprises cooling means, which are designed to feed cooling media to a defined position of the lamp, independent of the rotational position between support and body. Exemplary cooling means may include an electrical pump, designed to feed cooling media to the lamp. Suitable cooling media include cooling fluids and cooling gases, for example air.

To feed the cooling media to the lamp, any type of feed line may be used, as long as the rotational movement of the support is not substantially impeded. Exemplary, flexible tubes of appropriate length may be used to feed the cooling media to the lamp. According to a preferred embodiment, the cooling means comprise a duct, arranged on the second axis between the body and the support and designed to feed cooling media from the body to the support and thus to the lamp. In the present embodiment, the duct, because of the arrangement on the second axis does not impede the free rotation of the support, which is advantageous.

Preferably, the duct shall have a radial seal at the rotary joint between body and support to enable a safe transport of the cooling medium. In a most advantageous embodiment, the duct may also be used to carry the electrical connections for the lamp. Alternatively, the electrical connections between body and support may be formed using sliding contacts.

While the invention has been explained and the advantages have been illustrated in reference to lighting units, where the body is pivotally hinged to the holder, the invention is especially advantageous, when used within the before-mentioned moving heads and digital spotlights, respectively.

The invention is hereinafter described in detail with reference to the following figures, in which

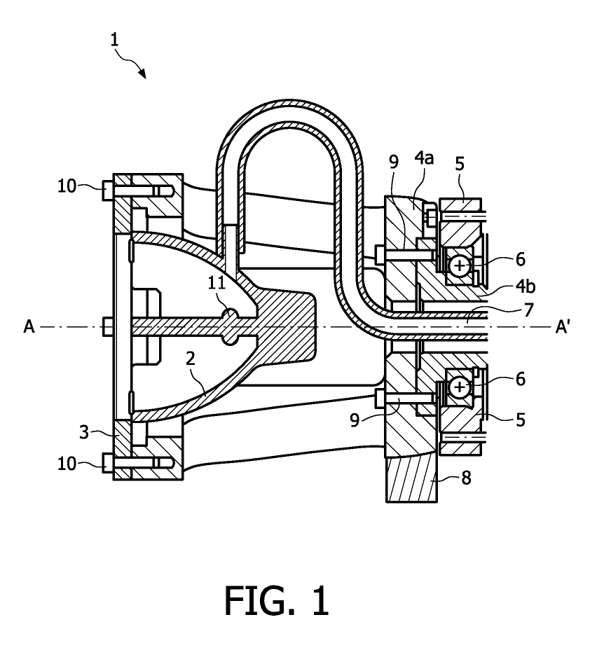

FIG. 1 shows a schematic side-view of an embodiment of a support according to the invention,

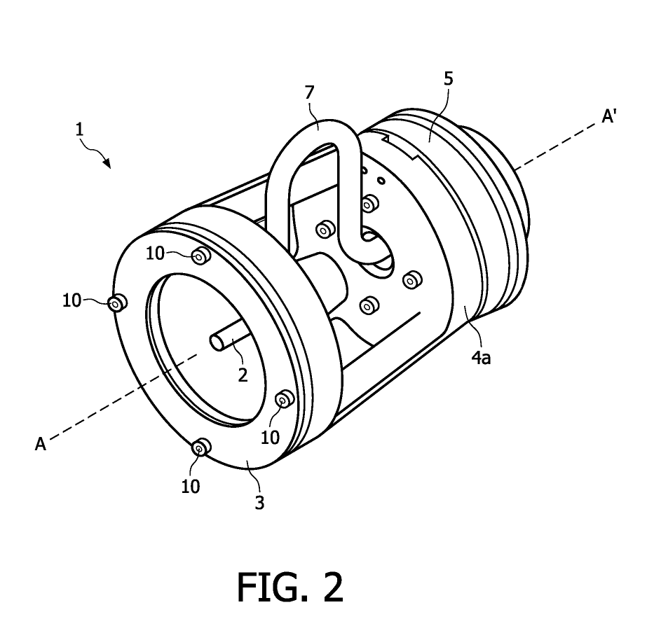

FIG. 2 shows a three-dimensional view of the embodiment, shown in FIG. 1 and

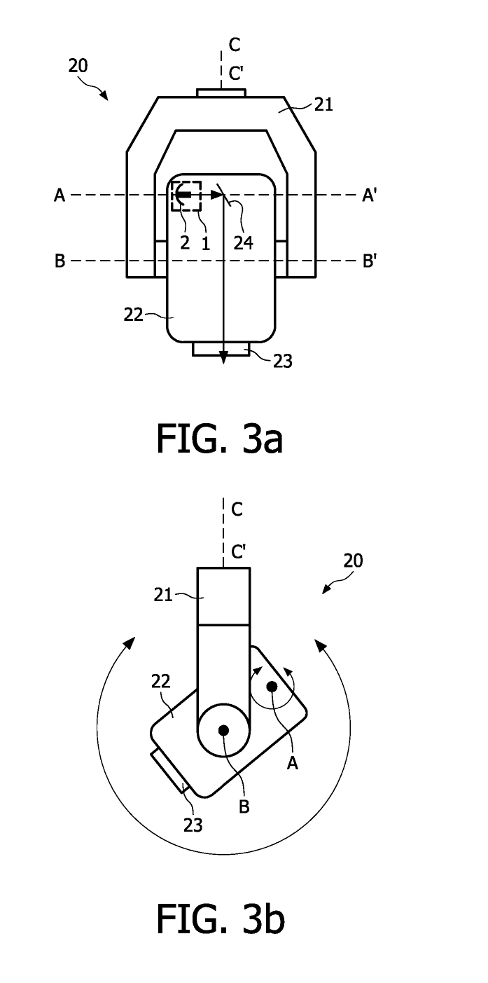

FIGS. 3a and 3b show schematic views of an embodiment of a lighting unit.

FIG. 1 shows a schematic side-view of an embodiment of a support 1 for use in a lighting unit according to the invention. The support 1 is designed to hold a CPL (compact power light) lamp 2 for use in a body of a lighting unit. The CPL lamp 2 is fixed at the support 1 between a front plate 3 and a base plate 4a. The front plate 3 is attached to the support 1 using screws 10, as can be seen from FIG. 2. The base plate 4a further comprises electrical connections (not shown), connected to the CPL lamp 2.

The base plate 4a is connected to a ring member 4b using screws 9. The ring member 4b is pivotally connected to a mounting section 5, using a ball bearing 6, which renders the support 1 rotatable around an axis A, A′. The mounting section 5 is rigidly connected to the body of the lighting unit.

In the area of the bearing 6 and along the axis of rotation A, A′, a cooling duct 7 is arranged, which is designed to feed cooling media from a suitable cooling pump within the body to a defined position on the CPL lamp 2. The cooling duct 7 is formed as a flexible tube, so that the free rotation of the bearing 6 is not impeded.

The cooling duct 7 may transport the cooling medium to a defined position of the CPL lamp 2, i.e. directly above the region of the light arc 11. Using CPL lamps, a cooling of the upside of the lamp bulb is necessary to prevent devitrification of the lamp bulb. Devitrification can occur at the upside of the lamp, since, due to convection inside the lamp bulb, the highest temperatures when operating the lamp are present at the topside of the lamp bulb, above the light arc 11. Because of this, it is necessary to assure, that the absolute orientation of the lamp 2 in the environment is maintained. Here, the term “topside” refers to the absolute position of the lamp 2 in the environment.

To assure that the cooling duct 7 always cools the topside of the lamp bulb of the CPL lamp 2, a mass element 8 is arranged on the base plate 4a of the support 1. The mass element 8 is arranged on a bottom side, opposite to the topside of the CPL lamp 2.

Upon a rotation of the body of the lighting unit around an axis, parallel to the axis A, A′, the mass element 8 will cause a torque due to gravity and will conversely rotate the support 1 against the body, so that the defined position of the CPL lamp 2 in the environment is maintained.

The before-mentioned rotational movements are explained in detail with reference to the FIGS. 3a and 3b. The figures show a moving head lighting unit 20. The moving head 20 comprises a holder 21, which is designed to mount the moving head 20, for example to the ceiling of a theatre. To achieve a high flexibility, the holder 21 may be mounted rotatable around an axis C,C′.

A body 22 of the moving head 20 is rotatable connected to the holder 21, so that the body 22 may rotate around an axis B,B′, as depicted in FIG. 3b. The body 22 is digitally controlled and a rotational movement is induced by an electrical motor and a suitable control system. The body 22 further comprises optical and electrical components of the moving head 20, such as a CPL lamp 2. The light of the CPL lamp 2 is directed to the front lens 23 of the lighting unit 20 using a mirror 24. The CPL lamp 2 is rotatable mounted to the body 22 on an axis A,A′, using a lamp support 1, as depicted by the dotted lines and explained above.

When the body 22 of the moving head 20 is rotated around the axis B,B′, the support 1 rotates conversely around the axis A,A′, so that the orientation of the CPL lamp 2 is maintained, independent of the rotational position between body 22 and holder 21. Using this design, a suitable cooling of the CPL lamp 2 using the cooling duct 7 can be ensured.

While the invention has been illustrated and described in detail in the drawings and the foregoing description, such illustration and description are to be considered illustrative or exemplary and not restrictive; the invention is not limited to the disclosed embodiments. For example, the support may be adapted to a specific type of lamp or may include other elements to maintain the position of the lamp.

Other variations to the disclosed embodiments can be understood and effected by those skilled in the art in practising the claimed invention from a study of the drawings, the disclosure and the appended claims. In the claims, the word “comprising” does not exclude other elements or steps and the indefinite article “a” or “an” does not exclude a plurality.

1. Lighting unit with a holder and a body, which body is pivotally hinged to the holder for rotation around at least a first axis and which body comprises a support for a lamp, wherein
the support (1) is pivotally hinged to the body (22) for rotation around a second axis, parallel to the first axis and
the support (1) holds a lamp (2), which lamp (2) emits light at least in the direction of the second axis.

2. Lighting unit according to claim 1, wherein the support (1) is operable for maintaining the orientation of the lamp (2) independent of the rotational position between body (22) and holder (21).

3. Lighting unit according to claim 1, wherein the support (1) comprises a lamp socket and/or a reflector.

4. Lighting unit according to claim 1, wherein the body (22) comprises cooling means, which are designed to feed cooling media to a defined position of the lamp (2), independent of the rotational position between support (1) and body (22).

5. Lighting unit according to claim 4, wherein the cooling means comprise a duct (7), arranged on the second axis between the body (22) and the support (1), designed to feed cooling media from the body (22) to the support (1).

6. Lighting unit according to claim 1, wherein the lamp (2) is a CPL lamp.

7. Lighting unit according to claim 1, wherein the lighting unit is designed as a moving head (20).

8. Lighting unit according to claim 1, wherein the support (1) comprises an unbalanced mass element (8).

9. Method for supporting an oriented lamp in a lighting unit, where the lighting unit comprises a holder (21) and a body (22), which body (22) is pivotally hinged to the holder (21) having at least a first axis of rotation and which body (22) comprises a support (1) for the lamp (2), which support (1) is pivotally hinged to the body (22), having a second axis of rotation, wherein upon a rotational movement of the body (22) around the first axis, the support (1) rotates conversely around the second axis, so that the defined orientation of the lamp (2) in maintained.

10. Method according to claim 9, wherein the support comprises a mass element (8) which, upon a rotational movement of the body (22) around the first axis, creates a torque, which torque rotates the support (1) conversely around the second axis.

11. Lamp socket for receiving a lamp with a receiving section and a base section, which base section is mountable to a lighting unit, wherein the receiving section is pivotally hinged to the base section for rotation around an axis, which is parallel to a direction of emitted light of a received lamp (2).

12. Lamp socket according to claim 11, wherein the axis corresponds to a direction of emitted light of the received lamp (2).
